(19) United States
(12) Patent Application Publication
(10) Pub. No.: US 2012/0008756 A1
(43) Pub. Date: Jan. 12, 2012

(54) METHOD AND SYSTEM FOR PROVIDING A COMMON CALLING PARTY IDENTIFIER THAT IS ASSOCIATED TO A SET OF COMMUNICATION DEVICES

(76) Inventors: Jonathan Allan Arsenault, Orleans (CA); Eric John Wolf, Stittsville (CA); David William Clark, Carp (CA)

(21) Appl. No.: 12/673,233

(22) PCT Filed: Dec. 28, 2007
(86) PCT No.: PCT/CA2007/002365

§ 371 Date: Feb. 12, 2010

(51) Int. Cl. H04M 1/57

(52) U.S. Cl. 379/142.17; 379/142.01

(57) ABSTRACT

A method and system for causing a common calling party identifier to be output in association with an outgoing call. The method comprising receiving over a network connection an indication of an attempt by a first communication device to place an outgoing call to a called party and determining a common calling party identifier associated to the first communication device and at least one other communication device. Each of the first communication device and the at least one other communication device is associated with a respective different network identifier. Once determined, the method further comprises causing the common calling party identifier to be conveyed in association with the outgoing call.

### FIELD OF THE INVENTION

The present invention relates generally to the field of calling party identifiers, and more specifically to providing a calling party identifier that is common to at least two communication device in association with an outgoing call.

### BACKGROUND

Most telephony service providers offer a variety of telephony features to their customers. These telephony features help telephony users to manage the way their incoming and outgoing communications are handled. Some non-limiting examples of such telephony features include call waiting, call forwarding, “find me/follow me” (FM/FM) call forwarding, distinctive ringing, selective call rejection, selective call acceptance, outgoing call blocking (or barring), etc.

One particular feature that is offered by many telephony service providers is “calling line identification (CLID) displaying” feature. For subscribers to this feature, the calling line identification associated with a calling party's communication device is displayed on the called party's communication device. This allows the called party to be aware of the calling line identification of the communication device associated with the calling party. The calling line identification can either be a phone number associated with the calling party communication device or a name associated with a user of the calling party communication device. In this manner, a called party will be able to determine who is calling them prior to answering the call.

However, a deficiency with this system is that a called party may not always recognize the calling line identification associated with the calling party communication device. As a result, the called party may not answer a call when he/she doesn't recognize the calling line identification associated with the calling communication device, which could lead to missed calls that would otherwise have been accepted.

Take for example the case of Alice, a telephony user who subscribes to the calling line identification (CLID) displaying feature. Alice has a friend named Bob who calls her on a fairly regular basis from his cell phone. As such, whenever Alice receives a call from Bob via his cell phone, Alice's phone displays Bob's calling line identification, which happens to be Bob's cell phone number. Over time, Alice has grown to recognize Bob's cell phone number such that whenever that calling line identification appears on her phone, she knows it is Bob who is trying to contact her. Then one day Bob calls Alice from his home phone, such that it is the calling line identification associated to his home phone (i.e. Bob's home phone number) that appears on Alice's phone. Given that Alice does not often receive calls from this phone number, Alice may not recognize the calling line identification associated with Bob's home phone, and thus choose not to answer the call. However, if Alice had known it was Bob who was initiating the communication, she would have answered the call.

In these and other situations, it is apparent that existing ways of displaying calling line identification information can be both ineffective and inefficient.

Thus, there remains a need in the industry to provide a technological solution that alleviates, at least in part, some of the deficiencies associated with the manner in which calling line identification information is provided.

### SUMMARY OF THE INVENTION

In accordance with a first broad aspect, the invention provides a method comprising receiving over a network connection an indication of an attempt by a first communication device to place an outgoing call to a called party and determining a common calling party identifier associated to the first communication device and at least one other communication device. Each of the first communication device and the at least one other communication device is associated with a respective different network identifier. The method further comprises causing the common calling party identifier to be output in association with the outgoing call.

In accordance with a second broad aspect, the invention provides a network entity comprising an input and a processing unit. The input is operative for receiving an indication of an attempt by a first communication device to place an outgoing call to a called party. The processing unit is operative for determining a common calling party identifier associated to the first communication device and at least one other communication device. Each of the first communication device and the at least one other communication device comprise a respective different network identifier. The processing unit is further operative for causing the common calling party identifier to be output in association with the outgoing call.

In accordance with a third broad aspect, the invention provides a computer-readable storage medium comprising a program element for execution by a network entity. The program element comprises a first program code for detecting receipt of an indication of an attempt by a first communication device to place an outgoing call to a called party and a second program code for determining a common calling party identifier associated to the first communication device and at least one other communication device. Each of the first communication device and the at least one other communication device comprise a respective different network identifier. The program element further comprises third program code for causing the common calling party identifier to be output in association with the outgoing call.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a communication network comprising a call processing entity for processing calls made from different communication devices in accordance with a non-limiting embodiment of the present invention;

FIG. 2 shows an example of the potential contents of the database shown in FIG. 1; and

FIG. 3 shows a method for causing a common calling party identifier to be output in association with an outgoing call in accordance with a first non-limiting embodiment of the present invention;

It is to be expressly understood that the description and drawings are only for the purpose of illustration of certain embodiments of the invention and are an aid for understanding. They are not intended to be a definition of the limits of the invention.

### DETAILED DESCRIPTION OF NON-LIMITING EMBODIMENTS

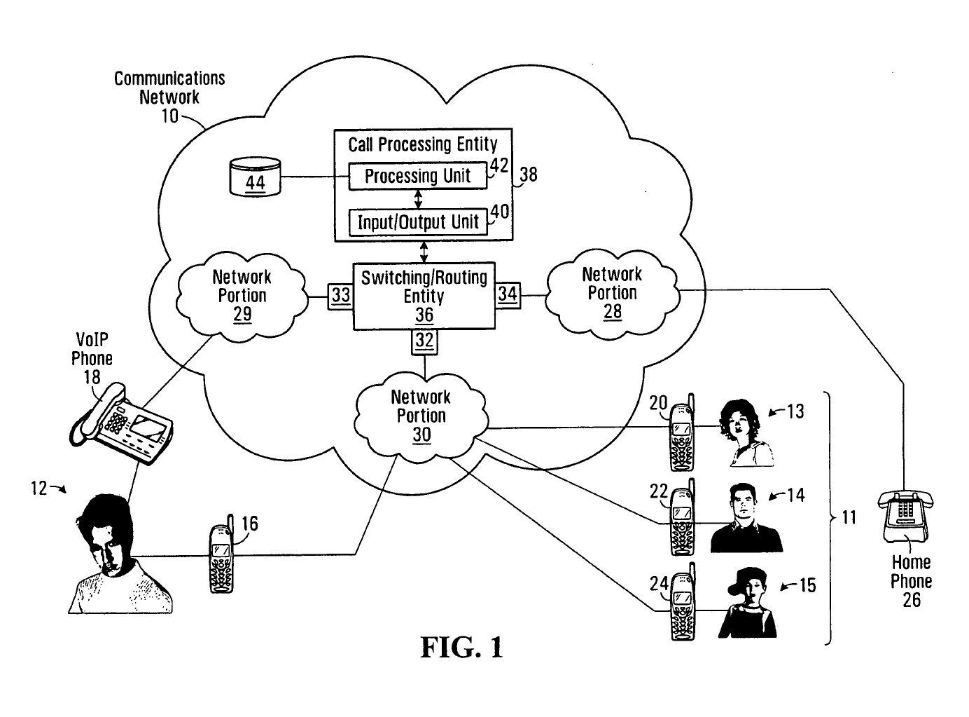

Shown in FIG. 1 is a non-limiting example of an architecture for a communications network 10 that is suitable for enabling communication between communication devices associated to different customers, such as customers 12, 13, 14 and 15, among others. Although only four customers 12, 13, 14 and 15 are shown in FIG. 1, it should be appreciated that the communications network 10 is suitable for enabling communication between hundreds of thousands of customers (if not more) via their associated communication devices.

In today's society, many telephony customers have multiple communication devices that they use on a regular basis in order to originate and receive phone calls, emails, instant messages and/or text messages, among other possibilities. It is not unusual for a given telephony user to have a cellular phone (or smart phone), a home phone and a work-place phone each having a separate phone number. In the example shown in FIG. 1, customer 12 is associated with two different communication devices; namely communication device 16 (that is a wireless phone) and communication device 18 (that is a VoIP phone). Either of communication devices 16 and 18 can be employed by customer 12 to effect telephonic communications, including handling incoming calls, originating outgoing calls, and participating in calls in progress.

Although communication device 16 is customer 12's wireless phone, and communication device 18 is customer 12's home phone (which in the example shown is a VoIP phone), it should be appreciated that each of the communication devices 16 and 18 could be any type of communication device suitable for originating, receiving and participating in communications with other communication devices through the communications network 10. For example, each one of the communication devices 16 and 18 could be any one of a wired Plain Old Telephony System (POTS) phone (including a cordless phone), a wireless phone (e.g., a cellular phone or other mobile communication device including a telephony-enabled personal digital assistant (PDA)), a Voice-over-Internet Protocol (VoIP) phone, a POTS phone equipped with an analog terminal adapter (ATA), a soft phone (i.e., a computer equipped with telephony software), or a telephony-enabled television (TV) unit (e.g., a set-top box connected to a television and a remote control). Depending on the functionality of each communication device 16 and 18, a call originated by, destined for, or in progress at either of the communication device 16 and 18 may be a voice call, a video call, a multimedia call, or any other type of call. Although customer 12 is associated with only two different communication devices 16 and 18, it should be appreciated that in various other embodiments, customer 12 could be associated with any number of communication devices.

In addition, most families, such as family 11 shown in FIG. 1, are associated with multiple communication devices, some of which might be shared by all members of the family. In the example shown, family 11 includes a mother (customer 13), a father (customer 14) and a child (customer 15) that each have a respective communication device with a unique phone number; namely communication devices 20, 22 and 24 (that are wireless phones). In addition, family 11 has a home phone (communication device 26) that is shared by all members of the family. As such, any one of customers 13, 14 and 15 could use either their cell phone, or the family's home phone 26 in order to effect telephonic communications, including handling incoming calls, originating outgoing calls, and participating in calls in progress.

Although in the example shown, the communication devices 20, 22 and 24 are wireless phones and the communication device 26 is a POTS home phone, in various other embodiments, family 11 could include any number of communication devices. In addition, the communication devices 20, 22, 24 and 26 associated with family 11 could be any of the type of communication devices listed above with respect to customer 12. Depending on the functionality of each of communication devices 20, 22, 24 and 26, a call originated by, destined for, or in progress at the communication device 20, 22, 24 and 26 may be a voice call, a video call, a multimedia call, or any other type of call.

The communications network 10 shown in FIG. 1 includes network portions 28, 29 and 30 that enable the handling of incoming calls, outgoing calls and calls in progress for communication devices 16, 18, 20, 22, 24 and 26. Each of the communication devices 16, 18, 20, 22, 24 and 26 is connected to a switching/routing entity 36 via one of the network portions 28, 29 and 30 of the communications network 10. As will be described in more detail below, the communications network 10 may comprise a portion of one or more of the Public Switched Telephone Network (PSTN), a wireless network (e.g., a cellular network), and a data network (e.g., the Internet). The switching/routing entity 36 enables the communication devices 16, 18, 20, 22, 24 and 26 to reach or be reached by any of various other communication devices (which are not shown for the sake of simplicity).

The nature of the network portions 28, 29 and 30 and the switching/routing entity 36 will depend on the nature of the communication devices 16, 18, 20, 22, 24 and 26 being used, and where the switching/routing entity 36 resides in the communications network 10. For example, communication devices 16, 20, 22 and 24 are wireless communication devices, and as such, the switching/routing entity 36 may reside in a wireless network (that could be specific to them). In addition, the network portion 30 may comprise a wireless link in combination with a base station and a network-side wireline link, and the switching/routing entity 36 may be part of a mobile switching center.

The communication device 26 is a wired POTS phone, and as such, the switching/routing entity 36 may reside in the PSTN environment. In addition, the network portion 28 may comprise a telephone line in the PSTN and the switching/routing entity 36 may be part of a central office switch.

The communication device 18 is a VoIP phone, (or a POTS phone equipped with an ATA), and as suck, the switching/routing entity 36 may reside in a data network. In such a case, the network portion 29 may comprise a digital communications link (e.g., Ethernet) and the switching/routing entity 36 may be part of a router (e.g., an edge router or a core router) or a softswitch. In accordance with a specific non-limiting example, the switching/routing entity 36 can be the MCS 5200 Soft Switch manufactured by Nortel Networks Limited of 8200 Dixie Road, Brampton, Ontario L6T 5P6, Canada, although it should be appreciated that this is but one non-limiting example among many possibilities within the scope of the present invention.

In yet another example of implementation, where a communication device (not shown) is a soft phone, its associated network portion may comprise a digital communications link (e.g., a digital subscriber line (DSL) link or a coaxial cable) and the switching/routing entity 36 may be part of a server equipped with a modem. It will be appreciated that various other implementations of network portions and the switching/routing entity 36 are possible (e.g., such as where the communication device is a telephony-enabled TV unit).

It will also be appreciated that, as shown in FIG. 1, the switching/routing entity 36 may span across different networks (i.e., PSTN, wireless, and/or data) in which case the switching/routing entity 36 comprises one or more gateways 32, 33 and 34 for enabling communication and interoperability between these networks. Alternatively, the switching/routing entity 36 may not include the gateways 32, 33 and 34, in which case the gateways could be part of a separate server that is not shown. Such gateways are well known to those skilled in the art and need not be described in further detail herein.

The switching/routing entity 36 is operative to effect switching/routing operations to help route an outgoing call originating from one of the communication devices 16, 18, 20, 22, 24 and 26 and destined for a called party device. In addition, the switching/routing entity 36 is operative to effect switching/routing operations to help route an incoming call originated at a calling party device and destined for one of the communication devices 16, 18, 20, 22, 24 and 26. Furthermore, the switching/routing entity 36 is communicatively coupled to a call processing entity 38, which is described later on, and interacts therewith. The switching/routing entity 36 comprises suitable hardware, firmware, software, control logic, or a combination thereof for implementing its functionality.

The call processing entity 38 is communicatively coupled to a database 44, and is operative to interact with the switching/routing entity 36 and the database 44 in order to effect various call processing operations when a communication device (such as the communication devices 16, 18, 20, 22, 24 and 26) receives an incoming call, originates an outgoing call, or participates in a call in progress.

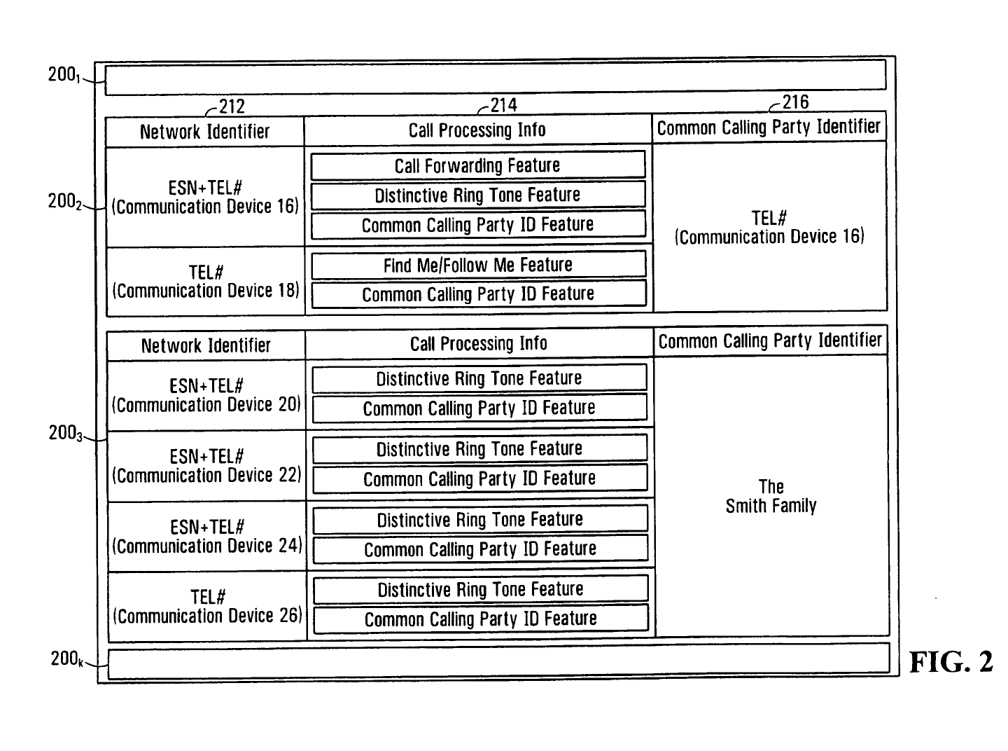

FIG. 2 shows a non-limiting example of the potential contents of the database 44. In the example shown, the database 44 stores a plurality of records 200₁-200ₖ each associated with a respective customer (such as customer 12) or group of customers (such as family 11). Each record stores a set of communication devices that may be associated with a single customer, such as customer 12, for example, or with a group of customers, such as family 11, for example. As such, it should be appreciated that the set of communication devices listed in record 200₂ all belong to a single customer, whereas the set of communication devices listed in record 200₃ belong to a group of customers.

In the embodiment shown, record 200₂ stores a list of communication devices associated with customer 12 and record 200₃ stores a list of communication devices associated with family 11. In accordance with the present invention, each of records 200₂-200₃ stores an association between its respective set of communication devices and a common calling party identifier associated with that set of communication devices.

More specifically, each of record 200₂ and 200₃ includes a network identifier 212 for identifying each communication device in the set of communication devices, call processing information 214 associated with each communication device in the set of communication devices, and a common calling party identifier 216 that is common to at least two of the communication devices in the set of communication devices. Each of these items will be described in more detail below.

The network identifier 212 is a unique identifier that is associated with each communication device, such that the call processing entity 38 can identify when a call is originating from, or destined for a given communication device. The network identifier 212 can be a telephone number identifying a telephone line associated with a POTS communication device, an electronic serial number (ESN) and telephone number associated with a wireless communication device, and an IP address and telephone number (and/or another Uniform Resource Identifier (URI) such as a Session Initiation Protocol (SIP URI)) used by a VoIP phone, an ATA-equipped POTS phone, or a softphone. Although not shown in FIG. 2, in addition to a network identifier 212, each entry or record may also include a party or account identifier, such as the name and/or billing address of one or more of the customers associated with a given set of communication devices.

Each entry further includes call-processing information 214 associated with a communication device. The call-processing information 214 associated with a given communication device can take on many forms. In the embodiment shown, the call processing information 214 is indicative of telephony features associated with each communication device. These telephony features can be features that are subscribed to by a user of the communication device or that are available to all communication devices being handled by a given service provider.

As will be described below, most telephony service providers provide a plurality of telephony services that will affect the way either an incoming communication, an outgoing communication, or a communication in progress is handled. As such, the telephony feature information that is stored in the database 44 is used by the call processing entity 38 during the processing of calls, or during the processing of other communications such as text messages, in order to apply appropriate telephony features.

Subscription to different telephony features may be completely independent from one customer to another or from one communication device to another, and there is no restriction on a number or combination of features that may be subscribed to by any one customer. In some cases, a customer may not subscribe to any telephony features, while in other cases a customer may subscribe to all available telephony features.

Some non-limiting examples of available telephony features include:
a call forwarding feature, whereby every incoming call destined for a given communication device associated to a customer is to be forwarded to a second communication device associated to the customer;
a selective call forwarding feature, whereby incoming calls that are originated by one or more communication devices associated with a selected given party, and destined for a communication device associated with the customer are to be forwarded to a second communication device associated with the customer.
a no-answer call forwarding feature, whereby an incoming call destined for a first communication device associated with the customer is to be forwarded to a second communication device associated with the customer if the incoming call is not answered on the first communication device within a predetermined period of time (e.g., ringing cycle);
a “find me/follow me” (FM/FM) call forwarding feature, whereby an incoming call is to be forwarded to a plurality of communication devices associated with the customer either simultaneously or sequentially (e.g., until the call is answered or until all the communication devices have been used and the call remains unanswered, in which case the call can be forwarded to a voicemail system);
a first distinctive ringing feature, whereby incoming calls destined for a communication device are to be announced by different audio signals (e.g., ring tones or songs) produced by the communication device when they originate from communication devices associated with different calling parties;
a selective call rejection feature, whereby an incoming call originated by any of one or more communication entities each associated with a given party and destined for a communication device associated with the customer is prevented from reaching the communication device associated with the customer;
a selective call acceptance feature, whereby only an incoming call originated by a communication device associated with a given party and destined for a communication device associated with the customer is allowed to reach the communication device associated with the customer;
a call waiting feature, whereby a communication device participating in a call in progress produces a notification for the user of the communication device of an incoming call destined for the communication device;
a calling line identification (CLID) displaying feature, whereby CLID information associated with a communication device originating a call that is destined for a communication device associated with the customer is displayed by the communication device associated with the customer;
a CLID blocking feature, whereby CLID information (e.g., a telephone number and/or a name or other party identifier) associated with a communication device with which the customer originates an outgoing call destined for a communication device belonging to another party is not provided to the communication device belonging to the other party; and
a speed calling feature, whereby an outgoing call destined for any of one or more communication devices that are associated with the same or different predetermined party can be originated by inputting into a communication device associated with the customer a specific code (e.g., a one or two digit code) that is shorter than the telephone number associated with the communication device for which the outgoing call is destined.

It is to be understood that these examples of telephony features are presented for illustrative purposes only and are not to be considered limiting in any respect as various other telephony features are or may become available.

A customer who subscribes to one or more of the telephony features listed above is generally able to configure the manner in which the telephony features work. This configuration can be done by interacting with a representative, an interactive voice response (IVR) unit, or a data network site (e.g., a web site) associated with a provider of the features.

As mentioned above, record 200₂ shown in FIG. 2 is associated with customer 12, such that the set of communication devices listed within record 200₂ are the communication devices 16 and 18 (as shown in FIG. 1) associated with customer 12. Record 200₂ includes a respective different network (or device) identifier for each of the communication devices 16 and 18, which in the embodiment shown include an ESN and telephone number associated with communication device 16 (which is a wireless phone) and an IP address and telephone number associated with communication device 18 (which is a VoIP phone). In addition, record 200₂ includes an indication of the call processing information for each of these communication devices. As shown, customer 12 subscribes to the “call forwarding” feature and the “distinctive ring tone feature” for communication device 16, and subscribes to only the “find me/follow me” feature for the communication device 18. In addition, and as will be described in more detail below, customer 12 also subscribes to a “common calling party ID” feature for both of communication devices 16 and 18.

Record 200₃, shown in FIG. 2 is associated with family 11, such that the set of communication devices listed within record 200₃ are the communication devices 20, 22, 24 and 26 associated with customers 13, 14 and 15 within family 11. Record 200₃ includes a respective different network identifier for each of communication devices 20, 22, 24 and 26, which in the embodiment shown includes an ESN and telephone number associated with communication device 20 (which is a wireless phone), an ESN and telephone number associated with communication device 22 (which is a wireless phone), an ESN and telephone number associated with communication device 24 (which is a wireless phone) and a telephone number associated with communication device 26 (which is a POTS phone). In addition, record 200₃ includes an indication of the call processing information for each of these communication devices. As shown, family 11 subscribes to the “distinctive ring tone” feature for each of communication devices 20, 22 and 24, and subscribes to the “call waiting” feature for communication device 26. In addition, and as will be described in more detail below, family 11 also subscribes to a “common calling party ID” feature for all of communication devices 20, 22, 24 and 26.

The “common calling party ID” feature is a calling feature that enables two or more communication devices in a set of communication devices to be associated with a common calling party identifier. In this way, it is the common calling party identifier that is issued with an outgoing call made by any of the communication devices associated to that common calling party identifier, regardless of which communication device originated the call. In this manner, a called party will not receive a different calling party identifier when it receives a call from different communication devices associated to that common calling party identifier.

As mentioned above, each of records 200₂ and 200₃ includes a common calling party identifier 216 that is common to all of the communication devices in the set of communication devices. Although the common calling party identifier 216 is shown as being common to all of the communication devices in each of records 200₂ and 200₃, it is possible that the common calling party identifier 216 could only be common to two or more of the communication devices in the set of communication devices.

The common calling party identifier can take on a variety of forms without departing from the spirit of the present invention. For example, the common calling party identifier 216 can be any one of a CID (caller identification), CNID (caller number identification) or CLID (calling line identification), which are known in the art. As such, the common calling party identifier 216 can be a phone number associated with any one of communication devices in the set of communication devices or could be the name of a customer using one or more of the communication devices in the set of communication devices. In yet a further alternative, the common calling party identifier could be the name of the group of customers using the set of communication devices, such as “The Smith Family”, or the name of a business with which the customer is associated, such as “Smith Jewelers”. In yet a further embodiment, the common calling party identifier could be a name indicative of a group of customers.

In accordance with a non-limiting example of implementation, having a common calling party identifier associated to a set of communication devices can be limited to only those customers that subscribe to the “common calling party ID” feature. As such, the “common calling party ID” feature would only be available to those customers who subscribe to this feature. In the embodiment shown in FIG. 2, both customer 12, and family 11, subscribe to the “common calling party ID” feature, and as such, have a common calling party identifier included in each of records 200₂ to 200₃. Alternatively, the “common calling party ID” feature could be included within each record 200₁-200ₖ without the customer needing to subscribe to this feature.

As described above, the “common calling party ID” feature is a calling feature that enables two or more communication devices in a set of communication devices to be associated with a common calling party identifier. This common calling party identifier can then be included with an outgoing call made by any of the communication devices associated to that common calling party identifier, regardless of which communication device originated the call. As such, if a called party subscribes to a Caller Line ID (CLID) display feature (or other calling party identifier display feature), when this called party receives an incoming call originating from any one of the communication devices belonging to a customer that has the “Common Calling Party ID feature”, it will be the common calling party identifier associated to those communication devices that will be displayed on the called party's communication device. In this manner, a called party will receive the same calling party identifier for a given customer, or group of customers, regardless of which communication device associated to the customer, or group of customers, is being used to originate the call.

For example, assume that customer 12 calls customer 14 by using his cell phone (communication device 16). In such a case, the calling party identifier that will appear on customer 14's communication device will be the common calling party identifier associated with the set of communication devices listed within record 200₂. For the sake of example, assume that the common calling party identifier for record 200₂ is the phone number associated with customer 12's cell phone (communication device 16). As such, regardless of whether customer 12 calls customer 14 using his cell phone (communication device 16) or his VoIP phone (communication device 18), the calling party identifier that will appear on customer 14's communication device will be the phone number associated with customer 12's cell phone (communication device 16). In this manner, customer 14 does not have to recognize two different phone numbers in order to know that it is customer 12 who is calling. Instead, customer 14 simply needs to recognize the phone number associated with customer 12's cell phone (communication device 16). Although in this example, the common calling party identifier associated with the set of communication devices listed in record 200₂ is customer 12's cell phone number, it should be appreciated that the common calling party identifier could be customer 12's VoIP phone number. Alternatively, the common calling party identifier could be customer 12's name, such as “Bob Jones”, such that no phone number will appear on the called party's communication device. In yet a further alternative, the common calling party identifier could be both customer 12's name and phone number.

Let us take another example wherein the wife (customer 13) of family 11 would like to call customer 12. Assume that the common calling party identifier for the set of communication devices associated with family 11 is “the Smith family”, and not an actual phone number associated to one of the communication devices in the set of communication devices listed in record 200₃. Regardless of whether customer 13 calls customer 12 from her cell phone (communication device 20) or from the family home phone (communication device 26), the calling party identifier that will be conveyed to customer 12 will be “the Smith family”.

With renewed reference to FIG. 1, and as mentioned above, the call processing entity 38 is operative to interact with the switching/routing entity 36 and the database 44 in order to effect various call processing operations when a communication device (such as any of the communication devices 16, 18, 20, 22, 24 and 26) connected to the switching/routing entity 36 receives an incoming call, originates an outgoing call, or participates in a call in progress. More particularly, the call processing entity 38 is operative to process calls arriving at the switching/routing entity 36. The processing of a given call by the call processing entity 38 can be viewed as the call processing entity 38 performing one or more operations to process the given call. In this embodiment, the call processing entity 38 is operative to process calls in accordance with a set of rules. Each rule may be defined by a condition, an operation to be performed if the condition is satisfied for a given call, and an operation to be performed if the condition is not satisfied for a given call (e.g., <condition> <operation to be performed if condition is satisfied> <operation to be performed if condition is not satisfied>). For a given rule, the condition may be defined in terms of one or more characteristics of a call. Examples of characteristics of a call are: its origin, which may be expressed, for instance, as a telephone number or other identifier (e.g., an IP address or SIP URI) associated with a communication device that originated the call; its intended destination, which may be expressed, for instance, as a telephone number or other identifier (e.g., an IP address or SIP URI) associated with a communication device for which the call is destined; and a time at which it was originated (e.g., a date, hour, minute, etc.). For a given rule, the condition may also be defined in terms of call processing information (in this case, telephony feature information) that is included in the records 200₁-200ₖ of the database 44. For a given rule, the operations to be performed based on whether the condition is satisfied depends on the nature of the given rule (e.g., route a call to its intended destination, forward a call in accordance with a call forwarding feature, cause production of an audio signal in accordance with a distinctive ringing feature, prevent establishment of an outgoing call in accordance with an outgoing call barring feature, etc.). The call processing entity 38 comprises suitable hardware, firmware, software, control logic, or a combination thereof for implementing its functionality. In accordance with a non-limiting example of implementation, the call processing entity 38 can be a softswitch, or any other type of IP application server.

In the embodiment shown, the call processing entity 38 includes a plurality of functional units, including an input/output unit 40 and a processing unit 42, whose functionality will be described in further detail below.

Continuing with FIG. 1, the call processing entity 38 for implementing the “common calling party ID” feature contemplated herein is communicatively coupled to the switching/routing entity 36, and the database 44. As will be further detailed later on, the call processing entity 38 is operative for accessing the records 200₁ to 200ₖ, within the database 44 upon receipt of an indication of an attempt to place a call (or issue an SMS or other text message) by a communication device. On the basis of the information within the database 44, the call processing entity 38 can process the call, or other type of communication, in accordance with the call processing information. In the case where a communication device that is attempting to make a call is a subscriber to the common calling party feature, the call processing entity 38 can determine the common calling party identifier associated with that communication device and cause that common calling party identifier to be communicated in association with the outgoing call (or SMS or text message) to the called party or destination communication device.

In some embodiments, the switching/routing entity 36, the call processing entity 38 and the database 44 may reside in a common network element of the communications network 10. In such embodiments, links between these components may be physical (i.e., wired or wireless) links or logical links. In other embodiments, different ones of the switching/routing entity 36, the call processing entity 38 and the database 44 may reside in different or common network elements of the communications network 10 that are interconnected via one or more physical links and possibly other elements (e.g., gateways) of the communications network 10. Also, although it is depicted in FIGS. 1 and 2 as being one component, the database 44 may be distributed in nature, i.e., it can have portions of its content stored in different memory units possibly located in different network elements of the communications network 10. For example, the call processing information shown may be stored in a memory unit dedicated to storing this information and distinct from a memory unit that stores other contents of the database 44 shown in FIG. 2.

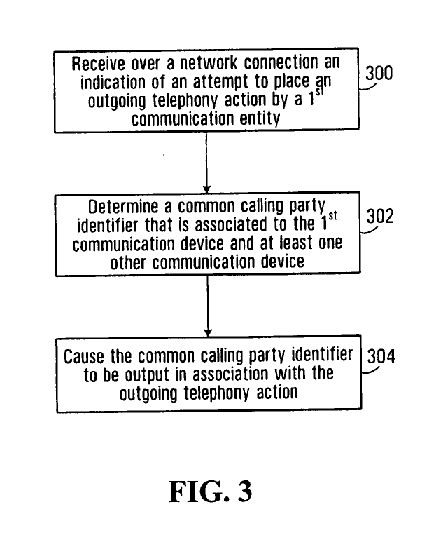

The interaction between the switching/routing entity 36, the call processing entity 38, and the database 44, for implementing the “common calling party ID” feature will now be described in more detail with reference to the flow chart shown in FIG. 3.

### Step 300

Firstly, at step 300, the call processing entity 38 receives over a network connection an indication of an attempt to place an outgoing call by a communication device. Although we will refer to an attempt to place an outgoing call in this example, it should be appreciated that the same procedure could take place in the case where an attempt to send an instant message, an SMS, a video communication, a multimedia communication or any other type of communication is sent. As such, although the present specification refers to an attempt to place a “call”, as used herein, the term “call” includes telephone calls, SMS messages, any other form of text messages, video messages, as well as any other type of communication initiated by the calling party.

For the sake of example, let us assume that customer 12 is attempting to place a call to customer 14 (the father) of family 11. More specifically, let us assume that customer 12 is using his cell phone (communication device 16) to call the cell phone (communication device 22) associated with customer 14.

As such, when customer 12 initiates the call, the call processing entity 38 will receive from the switching/routing entity 36 an indication that communication device 16 is attempting to make a call. In general, the indication of an attempt to make a call is firstly received at the switching routing entity 36 (via the gateway 32 in the case of the wireless communication device 16), and is passed to the call processing entity 38 such that the call processing entity 38 can process the intended call in the appropriate way. In a specific example of implementation, the indication of the attempt to place an outgoing call is received at the input/output unit 40 of the call processing entity 38.

When the call processing entity 38 receives the indication of an attempt to make a call, the call processing entity 38 also receives an indication of the network identifier 212 associated with the communication device that is attempting to place the call. In this manner, the call processing entity 38 can access call processing information associated to that communication device such that it knows how to process calls originating from that communication device. As such, in the case where communication device 16 is attempting to place an outgoing call, the call processing entity 38 will receive an indication of the attempt to make a call, and will receive information indicative that it is communication device 16 that is attempting to make the call. As mentioned above, and as shown in FIG. 2, the network identifier associated with communication device 16 can be the ESN and telephone number associated with communication device 16.

It should be appreciated that the indication of an attempt to place a call can be received at the call processing entity 38 either before or after the user of the communication device has entered call destination information. As such, keeping with the example above, the call processing entity 38 can receive an indication that customer 12 is attempting to make a call using communication device 16, before customer 12 has entered call destination information into the communication device. In such a case, the indication of the attempt to make a call can be received at the call processing entity 38 in response to an “off hook” condition at the communication device 16. In the case of POTS or VoIP phones, the “off hook” condition can be detected when a hand receiver is lifted off the hook. Or, in the case of a wireless phone, such as communication device 16, the off hook condition can be detected when the “send/talk” button is pressed, when a clamshell-type of phone is opened, or when a dedicated “off hook” button, or any other designated button, on the communication device is activated. This manner of detecting an attempt to make a call prior to the call destination information being provided is described in more detail in co-pending application entitled “A method and system for establishing a connection with a packet-based application server”, filed on Dec. 21, 2007 as an international (PCT) patent application, the contents of which are incorporated herein by reference. The inventors for this co-pending application are Jonathan Arsenault, David Clark, Sebastien Groulx, Matthew Rose, Nathan Archer, Eric Wolf and Yannick Lessard.

In an alternative embodiment, the indication of an attempt to make a call is not received at the call processing entity 38 until the call destination information indicative of the destination communication device has been entered into the calling communication device. For example, the call processing entity 38 does not receive an indication that communication device 16 is attempting to make a call, until the call destination information for customer 14 has been entered by customer 12 into his communication device 16.

The call destination information can be any identifier associated with a communication device. For example, the call destination information can be a phone number, an IP address or a name, among other possibilities. In the case where the call destination information is a phone number, this call destination information can be DTMF digits, CDMA or GSM packets or digital packets, that are entered via a numeric keypad, among other possibilities, into the communication device. In the case where the call destination information is an IP address, this information can be entered into the calling party communication device via a keypad, or via speech signals. Likewise, in the case where the call destination information is the name of the party being called, it can be entered into the communication device via speech signals such that the user simply needs to utter the name of the called party into the communication device. It should be appreciated that in the case where the call destination information is a phone number, this call destination information could also be entered into the communication device via speech signals.

### Step 302

At step 302, following receipt of an indication of an attempt to place a call, the call processing entity 38 determines a common calling party identifier associated to the communication device that is attempting to place the call (assuming that the communication device that is attempting to place the call subscribes to the “common calling party ID” feature, or that this feature is available to all customer). As mentioned above, the common calling party identifier will be common to the communication device that is attempting to place a call, and at least one other communication device in a set of communication devices to which the calling party communication device belongs.

More specifically, based at least in part on the network identifier 212 of the communication device and information stored in the database 44, the call processing entity 38 can determine a common calling party identifier that is associated with the communication device. In accordance with a specific example, the call processing entity 38 searches through the database 44 in order to locate a record 200₁-200ₖ that includes the network identifier of the communication device that is attempting to place the call. Once the record that includes the network identifier of the communication device that is attempting to place a call has been located, the call processing entity 38 can determine from that record the common calling party identifier 216 that is associated with that communication device.

Continuing with the above example wherein it is customer 12 that is attempting to place a call using communication device 16, upon receipt at the call processing entity 38 of the indication that communication device 16 is attempting to place a call, the call processing entity 38 will access the network identifier 212 associated with communication device 16. In this non-limiting example, the network identifier 212 associated with communication device 16 is the ESN and telephone number associated with wireless communication device 16. As mentioned above, this network identifier is provided to the call processing entity 38 upon receipt of the indication of the attempt to place a call, such that the call processing entity 38 knows which communication device is attempting to place a call.

The call processing entity 38 then searches through the records 200₁-200ₖ in order to locate the record that includes the network identifier 212 associated with communication device 16. Once record 200₂, which lists the set of communication devices associated with customer 12, has been located, the call processing entity 38 determines the common calling party identifier 216 that is common to communication device 16 and at least one other communication device. In the non-limiting example shown, the common calling party identifier associated to communication device 16 is common to all the communication devices in the set of communication devices listed in record 200₂.

In the embodiment shown, the common calling party identifier 216 associated with communication device 16 is the phone number associated with customer 12's cell phone (communication device 16). As such, regardless of whether customer 12 was attempting to place the call with his wireless phone (communication device 16) or with his VoIP phone (communication device 18) the common calling party identifier presented to a called party would be the same.

It should be appreciated that the common calling party identifier could also have been the phone number associated with customer 12's VoIP phone (communication device 18) without departing from the spirit of the invention. Likewise, the common calling party identifier could also have been customer 12's name, such as “Bob Jones”. In an alternative embodiment, the common calling party identifier could also have been customer 12's name and phone number.

Record 200₂ includes only two communication devices; namely communication device 16 and 18. As such, the common calling party identifier 216 is common to both of these communication devices. Assuming that record 200₂ included three or four communication devices that are all associated with customer 12, the common calling party identifier 216 could be associated with all the communication devices, or any subset of the communication devices.

### Step 304

At step 304, once the call processing entity 38 has determined the common calling party identifier 216 that is associated to the communication device that is attempting to place a call, the call processing entity 38 then causes the common calling party identifier 216 to be output in association with the outgoing call being made by the communication device. The manner in which the common calling party identifier is output to the called party can be done in a variety of ways, all of which are included within the scope of the present invention. For example, the common calling party identifier can be included within information forwarded to the called party's telephone equipment during the ringing signal or when the call is being set up but before the call is answered.

Continuing with the example described above, in the case where customer 12 is attempting to place a call to the communication device 22 that is associated with customer 14, once the call processing entity 38 has determined the common calling party identifier associated with communication device 16 that is being used to place the call, then that common calling party identifier is output to communication device 22 along with the outgoing call. As such, when communication device 22 starts to ring, it can also convey the common calling party identifier to customer 14. As such, customer 14, who is the called party, will see the common calling party identifier and decide whether or not to pick up the call. Advantageously, regardless of whether customer 12 uses communication device 16 or communication device 18 to call customer 14, the same common calling party identifier will be conveyed to customer 14.

The common calling party identifier can be conveyed to the called party in a variety of different ways. For example, the common calling party identifier may be displayed to the called party via alphanumeric characters on a display screen of the called communication device, or on a display of a separate associated device. Alternatively, the common calling party identifier may be conveyed to the called party via an audio announcement from speakers contained within the called communication device.

In accordance with a first non-limiting example, the common calling party identifier 216 can be output in association with the outgoing call regardless of whether or not the destination communication device is able to display or otherwise convey the common calling party identifier 216 to the called party. However, in accordance with an alternative example, the call processing entity may determine based on the destination information provided by the calling party communication device, whether the called party subscribes to a calling party identifier display feature, or whether the destination communication device has the hardware (such as a display screen or speakers) for conveying the common calling party identifier to the called party. In the case where the communication device associated with the called party is unable to convey the common calling party identifier to the called party, then the call processing entity may not output the common calling party identifier 216 to that called party communication device. However, in the case where the called party does subscribe to a common calling party identifier display feature, and the destination communication device is capable of conveying the common calling party identifier to the called party, then the call processing entity 38 will output the common calling party identifier to the called party.

In addition, the common calling party identifier found within database 44 can be user configurable. More specifically, the common calling party identifier 216 can be configured by one or more customers that belong to an associated set of the communication devices that belong to a set of associated communication devices. For example the head of the household may be the one to configure the common calling party identifier.

For example, in the case of the set of communication devices included within record 200₂, namely communication devices 16 and 18, customer 12 can configure the common calling party identifier in a variety of ways. For example, the configuration can be done by interacting with a representative of the service provider, by interacting with an IVR or by using a website associated with the service provider. In accordance with a non-limiting example, customer 12 can configure the common calling party identifier 216 contained within record 200₂ by selecting one of the respective network identifiers associated with the communication devices listed within record 200₂. For example, customer 12 can select the common calling party identifier 216 from one of the network identifiers 212 associated with the set of communication devices included within record 200₂; namely communication devices 16 and 18. In most cases, the network identifiers 212 associated with the communication devices are suitable for use as a common calling party identifier. As such, the customer 12 could select either the telephone number of his wireless phone (communication device 16) or the telephone number of his VoIP phone (communication device 18) as the common calling party identifier. In addition to selecting the common calling party identifier 216 from one of the network identifiers associated with the communication devices, the user could configure the common calling party ID such that the calling number and/or the caller name that appears is set by the user. In such a manner, the user can configure how the calling number ID will appear (i.e. with or without an area code, with or without the calling name ID, what the caller name will be, etc).

In yet a further example, customer 12 could configure the common calling party identifier 216 such that it conveys his name, or the name to which the account is registered. For example, assuming customer 12's name is Bob Jones, customer 12 could configure the common calling party identifier to be “Bob Jones” or “Mr. Jones”, among other possibilities. In addition, in the case where customer 12 has a small home-based business called “Jones Solutions”, then the common calling party identifier could be configured to indicate “Jones Solutions” to all called parties, regardless of whether customer 12 is calling from his wireless phone (communication device 16) or his VoIP phone (communication device 18). The user could enter how the name should appear (i.e. all small case, all upper case, etc.). The user could also enter the actual name that he/she would like to appear.

In accordance with a still further example of implementation, customer 12 could configure the common calling party identifier 216 such that it is different depending on different circumstances, such as depending on time of day, or day of the week, among other possibilities. For example, customer 12 may configure the common calling party identifier 216 such that the common calling party identifier associated to customer 12's set of communication devices is “Jones Solutions” between 9-5 on weekdays, but is “Bob Jones” at all other times. These sorts of rules can be stored within the call processing information 214 associated with the set of communication devices in record 200₂. As such, the call processing entity 38 would consider these sorts of instructions when determining a common calling party identifier as described above with respect to step 302 of FIG. 3.

As described above, the common calling party identifier could be either a phone number or a caller's name. In general, there are two distinct parts to an incoming call announcement; namely the calling number and the caller's name. Therefore, in an alternative embodiment, it is possible that the common calling party identifier would include both a number and a name that are to be conveyed to a called party. As described above, both of the calling number and the caller's name could be configured by a user.

In yet a further embodiment, in addition to providing a common calling party identifier, the call processing entity 38 may be operative to also output the network identifier, or some other identifier, associated with the calling communication device to the called party in addition to the common calling party identifier. For example, in the case of family 11, the call processing entity 38 may detect that it is customer 15's cell phone (communication device 24) that is being used to place an outgoing call and that the common calling party identifier is “The Smith Family”. In addition to outputting “The Smith Family” to a called party, the call processing entity 38 may also output the phone number associated with communication device 24, or the name of customer 15. As such, the called party would receive both an indication of the common calling party identifier and an indication of the actual communication device or the customer that is placing the outgoing call.

Those skilled in the art will appreciate that, in some embodiments, certain functionality of a given component described herein (including the switching/routing entity 36 and the call processing entity 38) may be implemented as pre-programmed hardware or firmware elements (e.g., application specific integrated circuits (ASICs), electrically erasable programmable read-only memories (EEPROMs), etc.) or other related elements. In other embodiments, a given component described herein (including the switching/routing entity 36 and the call processing entity 38) may comprise a processor having access to a code memory which stores program instructions for operation of the processor to implement functionality of that given component. The program instructions may be stored on a medium which is fixed, tangible, and readable directly by the given component (e.g., removable diskette, CD-ROM, ROM, fixed disk, USB key, etc.). Alternatively, the program instructions may be stored remotely but transmittable to the given component via a modem or other interface device connected to a network over a transmission medium. The transmission medium may be either a tangible medium (e.g., optical or analog communications lines) or a medium implemented using wireless techniques (e.g., microwave, infrared or other wireless transmission schemes).

While specific embodiments of the present invention have been described and illustrated, it will be apparent to those skilled in the art that further modifications and variations can be made without departing from the scope of the invention as defined in the appended claims.

1. A method, comprising:
a) receiving over a network connection an indication of an attempt by a first communication device to place an outgoing call to a called party;
b) determining a common calling party identifier associated to said first communication device and at least one other communication device, each of said first communication device and said at least one other communication device being associated with a respective different network identifier;
c) causing the common calling party identifier to be conveyed in association with the outgoing call.

2. A method as defined in claim 1, wherein the first communication device and the at least one other communication device belong to a set of communication devices, the set of communication devices comprising a plurality of communication devices, each of the plurality of communication devices in the set of communication devices having a respective different network identifier.

3. A method as defined in claim 1, wherein determining the common calling party identifier associated to the first communication device is performed at least in part on the basis of the network identifier associated with the first communication device.

4. A method as defined in claim 2, wherein the plurality of communication devices in the set of communication devices are all associated to a single user.

5. A method as defined in claim 2, wherein the plurality of communication devices in the set of communication devices comprise at least two communication devices that are associated with different users.

6. A method as defined in claim 1, wherein the common calling party identifier is configurable by a user of at least one of the first communication device and the at least one other communication device.

7. A method as defined in claim 6, wherein the common calling party identifier can be selected from a set of calling party identifiers by a user of at least one of the first communication device and the at least one other communication device.

8. A method as defined in claim 1, further comprising determining a different common calling party identifier at different times of day.

9. A method as defined in claim 1, wherein the respective different network identifiers associated to each of the first communication device and the at least one other communication device are different calling party identifiers associated to the first communication device and the at least one other communication device.

10. A method as defined in claim 9, wherein the common calling party identifier is one of the respective different calling party network identifiers associated to the first communication device and the at least one other communication device.

11. A method as defined in claim 1, wherein the first communication device is one of a POTS communication device, a wireless communication device and a VoIP communication device.

12. A method as defined in claim 1, further comprising causing the common calling party identifier to be displayed on a communication device of the called party.

13. A network entity configured to implement the method defined in claim 1.

14. A network entity comprising:
a) an input for receiving an indication of an attempt by a first communication device to place an outgoing call to a called party;
b) a processing unit for
determining a common calling party identifier associated to said first communication device and at least one other communication device, each of said first communication device and said at least one other communication device comprising a respective different network identifier; and
causing the common calling party identifier to be conveyed in association with the outgoing call.

15. A network entity as defined in claim 14, wherein the first communication device and the at least one other communication device belong to a set of communication devices, the set of communication devices comprising a plurality of communication devices, each of the plurality of communication devices in the set of communication devices having a respective different network identifier.

16. A network entity as defined in claim 14, wherein the processing unit determines the common calling party identifier associated to the first communication device at least in part on the basis of the network identifier associated with the first communication device.

17. A network entity as defined in claim 15, wherein the plurality of communication devices in the set of communication devices are all associated to a single user.

18. A network entity as defined in claim 15, wherein the plurality of communication devices in the set of communication devices comprise at least two communication devices that are associated with different users.

19. A network entity as defined in claim 14, wherein the common calling party identifier is configurable by a user of at least one of the first communication device and the at least one other communication device.

20. A network entity as defined in claim 19, wherein the common calling party identifier can be selected from a set of calling party identifiers by a user of at least one of the first communication device and the at least one other communication device.

21. A network entity as defined in claim 14, wherein the processing unit determines a different common calling party identifier at different times of the day.

22. A network entity as defined in claim 14, wherein the respective different network identifiers associated to each of the first communication device and the at least one other communication device are different calling party network identifiers associated to the first communication device and the at least one other communication device.

23. A network entity as defined in claim 22, wherein the common calling party identifier is one of the respective different calling party identifiers associated to the first communication device and the at least one other communication device.

24. A network entity as defined in claim 14, wherein the first communication device is one of a POTS communication device, a wireless communication device and a VoIP communication device.

25. A network entity as defined in claim 14, further comprising an output for releasing the common calling party identifier in association with an outgoing call.

26. A computer-readable storage medium comprising a program element for execution by a network entity, said program element comprising:
a) first program code for detecting receipt of an indication of an attempt by a first communication device to place an outgoing call to a called party;
b) second program code for determining a common calling party identifier associated to said first communication device and at least one other communication device, each of said first communication device and said at least one other communication device comprising a respective different network identifier; and
c) third program code for causing the common calling party identifier to be conveyed in association with the outgoing call.
